(19) United States
(12) Patent Application Publication
(10) Pub. No.: US 2026/0199848 A1
(43) Pub. Date: Jul. 16, 2026

(54) DEVICE FOR AGITATING FLUID PRODUCTS

(71) Applicant: COROB S.P.A., San Felice Sul Panaro (IT)

(72) Inventors: Rooy Hans Ferer, Cento (IT); Rudy Roncato, Cavezzo (IT)

(21) Appl. No.: 19/128,504

(22) PCT Filed: Nov. 8, 2023
(86) PCT No.: PCT/IT2023/050247

§ 371 Date: May 8, 2025

(30) Foreign Application Priority Data
Nov. 10, 2022 (IT) 102022000023163

(51) Int. Cl. B01F 27/1125; B01F 27/191; B01F 27/808

(52) U.S. Cl. CPC B01F 27/11253; B01F 27/191; B01F 27/808

(57) ABSTRACT

An agitator device is configured to be positioned, during use, inside a tank which contains at least one fluid, and includes one or more agitation vanes integral with a support element which is rotatable by means of a corresponding drive or drive means.

### CROSS-REFERENCE TO RELATED APPLICATION(S)

This application is a U.S. National Stage Application of PCT International Application No. PCT/IT2023/050247, filed on Nov. 8, 2023, entitled “DEVICE FOR AGITATING FLUID PRODUCTS,” which claims priority to Italian Patent Application No. 102022000023163, filed on Nov. 10, 2022, entitled “DEVICE FOR AGITATING FLUID PRODUCTS,” which are incorporated herein by reference in their entireties.

### TECHNICAL FIELD

The present disclosure concerns a device for agitating fluid products, such as coloring liquids, bases for paints, varnishes, enamels, inks and suchlike, suitable to be housed in a tank of a machine for dispensing or distributing such fluid products.

### BACKGROUND

Devices for agitating fluid or powder products that are contained inside a tank are described in prior art documents JP 2014 226333, CN 110882641, GB 1553990 e U.S. Pat. No. 5,358,328.

Even in the field of the machines for dispensing, or distributing, fluid products, such as for example dyes of different shades or colors, able to be mixed together and/or added to a base substance in order to create a varnish, or a paint, of a certain color the use of agitator devices is known that are arranged inside each tank containing the coloring fluid products.

Known machines normally comprise a plurality of containers containing a certain dye, which are selectively connectable to one or more delivery nozzles and are associated with respective pump means that cause the selective delivery of the fluid product contained therein in a suitably chosen amount, for example with the aid of an electronic processor.

Each container comprises inside it a selectively activatable agitator device, such as for example the device described in WO 2022/113143, which is able to prevent the heavier components present in the fluid from depositing on the bottom of the container itself, which would result in an unwanted drying of the fluid. The agitator device is also able to prevent the various components present in the fluid—typically characterized by different densities/viscosities—from separating, in order to avoid product degradation.

Known agitator devices normally comprise a substantially vertical shaft, made to rotate by a corresponding drive or drive means and provided with a series of vanes for agitating the fluid product contained inside the tank.

The conformation and positioning of these agitation vanes, however, do not guarantee an optimal and uniform mixing of the fluid product inside the tank. The agitation vanes can be, for example, inclined with respect to a horizontal direction, reciprocally distanced from each other by a predefined distance and disposed in diametrically opposite positions with respect to the shaft.

Examples of known agitator devices of this type are described in patent documents EP 1744826 and EP3244991.

Furthermore, zones can form inside the tank in which the fluid product is substantially stationary, or it is not moved by the agitation vanes at a speed suitable to guarantee an effective and uniform mixing.

Moreover, in some cases, especially for fluid products of a certain density, the agitator devices are subjected to considerable stresses, given the high resistant torque caused by the fluid products, which can lead to overloading of the drive and motion transmission means, thus causing premature wear or damage.

There is therefore the need to perfect a device for agitating fluid products that can overcome at least one of the disadvantages of the state of the art.

In particular, one purpose of the present disclosure is to provide a device for agitating fluid products that is capable of guaranteeing a rapid, effective and uniform mixing inside a tank.

Another purpose of the present disclosure is to provide a device for agitating fluid products that is capable of reducing stationary zones, or zones with low mixing speed.

Another purpose of the present disclosure is to provide a device for agitating fluid products that allows to limit the resistant torque during the mixing operations, and thus limit the efforts required to the means for driving the agitation vanes.

Another purpose of the present disclosure is to provide a tank for containing fluid products comprising at least one agitator device.

The Applicant has devised, tested and embodied the present disclosure to overcome at least some of the shortcomings of the state of the art and to obtain these and other purposes and advantages.

### SUMMARY

An agitator device according to the present disclosure is configured to be positioned, during use, inside a tank for containing at least one fluid.

According to one aspect of the present disclosure, the agitator device comprises a plurality of agitation vanes integral with a support element which is rotatable by means of a corresponding drive or drive means, the agitation vanes being positioned on the support element according to a distribution in pairs.

According to one aspect of the present disclosure, each of the pairs of the vanes defines a variable section channel delimited at the upper and lower part by the vanes, the channel being configured so that the fluid passes through it, following a substantially helical path in such a way that each variable section channel is part of the path.

In other words, the pairs of vanes are positioned on the support element in such a way that each variable section channel is substantially part of the path, along which the fluid flows in succession through the plurality of channels defined by the pairs of vanes.

Thanks to the variable section channels defined between pairs of vanes, this agitator device is able to guarantee a rapid, effective and uniform mixing of the fluid.

This agitator device is also able to reduce stationary zones, or any zones with slow mixing speeds, and limit the resisting torque during mixing operations, thus limiting the efforts required by the drive or drive means which make the support element rotate.

According to another aspect of the present disclosure, the inlet section of each of the channels is larger than an outlet section.

According to another aspect of the present disclosure, each of the channels has a passage section that substantially decreases from the inlet section to the outlet section.

This conformation of the channels is advantageous because it allows to determine an acceleration of the flow of the passing fluid.

According to another aspect of the present disclosure, in each of the pairs, the vanes are inclined from the bottom upward, with the inlet section located at the end of the channel being disposed at the bottom and the outlet section located at the end of the channel being disposed at the top.

According to another aspect of the present disclosure, each of the pairs comprises an upper vane, that is substantially flat, and a lower vane, that is concave in an upward direction, that is, toward the respective variable section channel.

According to another aspect of the present disclosure, the pairs of vanes located on one side of the support element are offset in height with respect to the pairs located on the opposite side.

According to another aspect of the present disclosure, the pairs of vanes located on said one side are vertically aligned with each other, forming a first column of vanes, and the pairs of vanes located on said opposite side are vertically aligned with each other, forming a second column of vanes.

According to another aspect of the present disclosure, the outlet section of the pairs of vanes located on one side forming the first column is partly overlapping in the vertical direction, for at least one segment, with the inlet section of the pairs of vanes located on the opposite side forming the second column.

According to another aspect of the present disclosure, the vanes located on the one side of the support element are in a diametrically opposite position with respect to the vanes located on the other side.

According to another aspect of the present disclosure, the support element comprises at least two vertical profiles protruding from two opposite parts of the support element, wherein each of the vertical profiles is interposed between the first and second column of vanes.

According to another aspect of the present disclosure, the agitator device comprises at least one vane positioned in proximity to the lower end of the support element and located, during use, in proximity to the bottom of the tank.

The present disclosure also concerns a tank for containing at least one fluid product, comprising at least one agitator device for agitating the at least one fluid product as defined above.

### BRIEF DESCRIPTION OF THE DRAWINGS

These and other aspects, characteristics and advantages of the present disclosure will become apparent from the following description of some embodiments, given as a non-restrictive example with reference to the attached drawings wherein:

FIG. 1 is a three-dimensional view of an agitator device according to the present disclosure housed inside a tank for containing at least one fluid product;

FIG. 2 is a front view of the agitator device of FIG. 1;

FIG. 3 is a lateral view of the agitator device of the previous drawings;

FIG. 4 is an enlarged lateral view of a part of the agitator device of FIG. 3;

FIG. 5 is a top view of the agitator device of the previous drawings.

We must clarify that the phraseology and terminology used in the present description, as well as the figures in the attached drawings also in relation as to how described, have the sole function of better illustrating and explaining the present disclosure, their purpose being to provide a non-limiting example of the disclosure itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DETAILED DESCRIPTION

We will now refer in detail to the possible embodiments of the present disclosure, of which one or more examples are shown in the attached drawings, by way of a non-limiting illustration. The phraseology and terminology used here is also for the purposes of providing non-limiting examples.

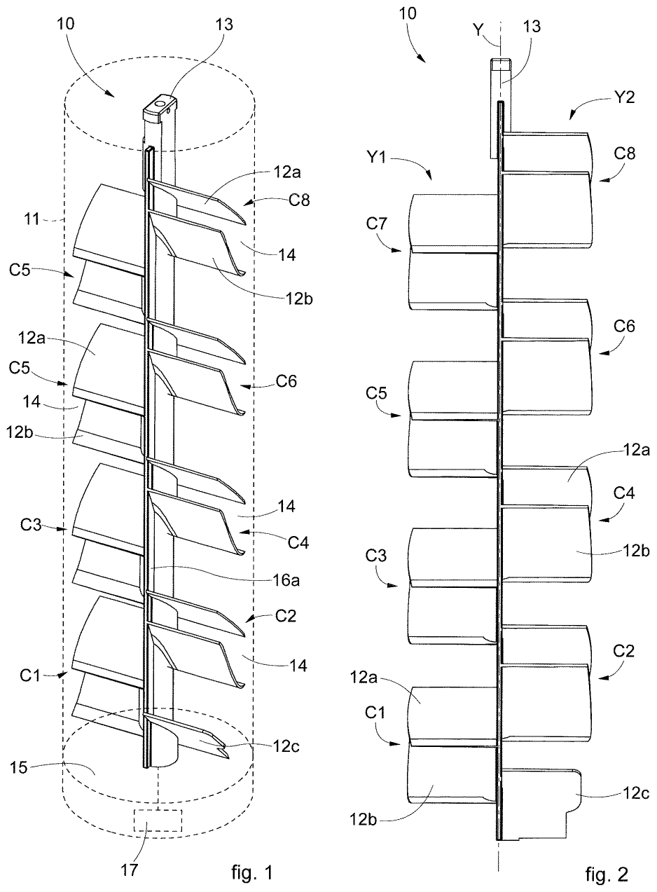

With reference to the attached drawings, see in particular FIGS. 1, 2 and 3, an agitator device 10 according to the present disclosure is configured to be positioned, during use, inside a tank 11 for containing at least one fluid, schematized with a dashed line in FIG. 1. The agitator device 10 comprises one or more agitation vanes 12a, 12b for agitating the at least one fluid, which are integral with a support element 13 which is rotatable by means of a corresponding drive or drive means 17. The support element 13 is in particular configured as a shaft made to rotate by the drive or drive means 17, for example an electric motor or other.

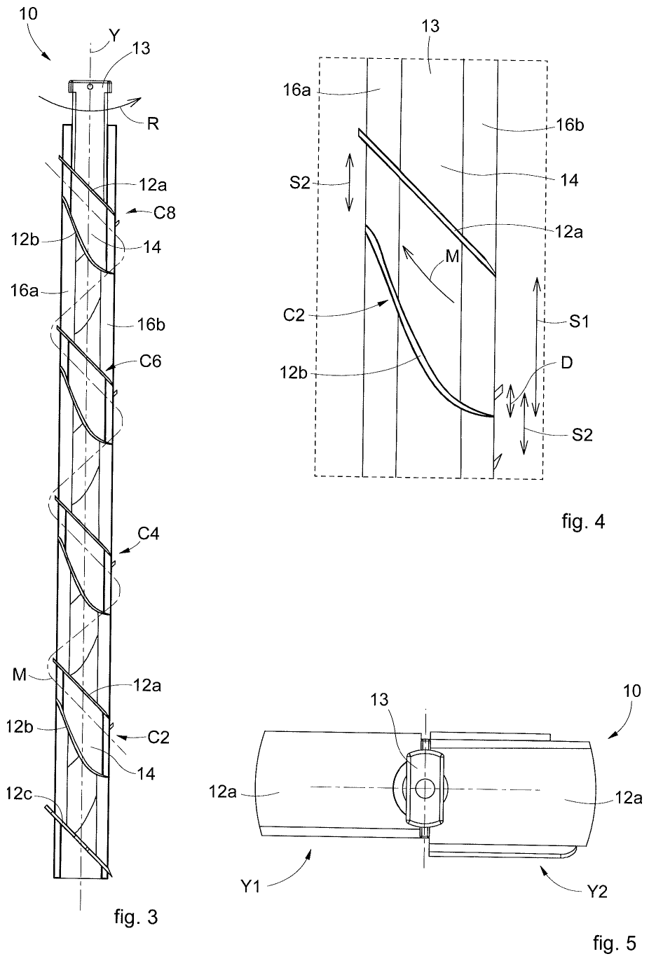

The support element 13 develops around a substantially vertical axis Y (FIGS. 2 and 3), around which the support element 13 can rotate, as indicated by the arrow R in FIG. 3.

The vanes 12a, 12b are positioned on either side of the support element 13 and are distributed according to a disposition in pairs C1-C8. Each pair C1-C8 defines a channel 14 with a variable section, delimited at the upper part by the vane indicated in the drawings with reference 12a, or upper vane, and at the lower part by the vane indicated with reference 12b, or lower vane.

As can be seen in particular in FIG. 4, the inlet section S1 of each of the channels 14 defined by each pair C1-C8 of vanes 12a, 12b is larger than the outlet section S2. Each channel 14 substantially has a passage section that decreases from the inlet section S1 to the outlet section S2. In the channel 14, the fluid undergoes an upward acceleration and moves along a helical path M (FIG. 3) when the support element 13 is rotated.

Each of the channels 14, therefore, by accelerating the fluid in an upward direction, makes the mixing faster and more homogeneous. The fluid exiting from a channel 14 defined by a pair of vanes 12a, 12b, for example the pair C1, flows to the inlet of the next pair, for example the pair C2, giving rise to an upward accelerated motion along the path M.

More generally, the pairs C1-C8 are positioned on the support element 13 in such a way that each variable section channel 14 is part of the path M, see FIG. 4, in which the path segment inside the channel 14 is schematized as a rectilinear and inclined segment of the overall helical path M.

In each of the pairs C1-C8, the vanes 12a, 12b are inclined from the bottom upward, with the inlet section S1 disposed in correspondence with the end of the channel 14 disposed at the bottom, and the outlet section S2 disposed in correspondence with the end of the channel 14 disposed at the top.

We must clarify that the inclination of the vanes 12a, 12b is correlated to the direction of rotation of the support element 13, to guarantee the latter a rotation such that the fluid enters the channel from the inlet section S1. In the example given here, with the inclination of the vanes described above, the rotation element rotates counterclockwise, as indicated in FIG. 3.

The upper vane 12a is substantially flat, while the lower vane 12b is curved upward, or concave upward. The section narrowing of the channel 14 is substantially created by the conformation of the vane 12b.

As can be observed in particular in FIG. 2, the pairs C1, C3, C5, C7 of vanes 12a, 12b located on one side of the support element 13 are offset in height with respect to the pairs C2, C4, C6, C8 located on the opposite side.

The two groups of pairs, C1, C3, C5, C7 and C2, C4, C6, C8, respectively, located on one side and the other of the support element 13 are vertically aligned with each other, see also FIG. 2, so as to substantially form a first column Y1 and a second column Y2 of vanes 12a, 12b. The first and second column Y1, Y2 of vanes 12a, 12b are vertical, parallel to each other and to the vertical axis Y.

The vanes 12a, 12b located on one side of the support element 13, belonging for example to the column Y1 formed by the pairs C1, C3, C5, C7, are in a diametrically opposite position with respect to the vanes 12a, 12b located on the other side of the support element 13, belonging for example to the column Y2 formed by the pairs C2, C4, C6, C8.

As best seen in the enlargement of FIG. 4, the outlet section S2 of the pairs C1, C3, C5, C7 of vanes 12a, 12b located on one side, which are aligned to form the first column Y1, is partly overlapping, for at least one segment D, with the inlet section S1 of the remaining pairs C2, C4, C6, C8 of vanes 12a, 12b located on the opposite side, which are aligned to form the second column Y2. This overlap for at least the segment D not only guarantees the continuity of the flow of the fluid along the path M, but also gives an amplification effect to the acceleration thrust of the fluid in the passage from one pair to the other.

Each of the vanes 12a, 12b can have, when viewed from above, a quadrangular shape, for example rectangular, square, trapezoidal or suchlike.

The agitator device 10 comprises at least one further vane 12c positioned in proximity to the lower end of the support element 13 and located, during use, in proximity to the bottom 15 of the tank 11. This further vane 12c is inclined from the bottom upward with respect to the path M of movement of the fluid. The further vane 12c in particular is substantially parallel to the vanes 12a disposed in the same column Y2.

The further vane 12c substantially contributes to generating the substantially helical motion in the path M, it prevents the sedimentation of the fluid and also contributes to reducing the stationary zones in the lower part of the tank 11.

The support element 13 also comprises at least two vertical profiles 16a, 16b (FIGS. 3 and 4) protruding from one and the other side of the support element 13.

The vertical profiles 16a, 16b are preferably substantially created along the entire extension of the support element 13 and alternate with the columns Y1 and Y2 of vanes 12a, 12b. The vertical profiles 16a, 16b are diametrically opposite, at 180° with respect to each other with reference to a central axis of the support element 13. The vertical profiles 16a, 16b are conformed as fins and contribute to moving the fluid present in the zones near the support element 13. Their presence also allows to create vanes 12a, 12b with larger sizes, since the side of the vanes 12a, 12b which is adjacent to the support element 13 can be supported, as well as by the latter, also by the protruding vertical profiles 16a, 16b.

This agitator device 10 advantageously guarantees a high and uniform mixing of the fluid in the tank 11, the stationary zones within the fluid volume are reduced and the increase in the resistant torque generated by the fluid during mixing is limited.

The conformation and disposition of the vanes 12a, 12b, as shown and described, also advantageously allow to reduce the distance between them and the internal walls of the tank 11, further contributing to improving the speed and uniformity of the mixing.

This agitator device 10 has shown it can also be used in tanks 11 of any diameter whatsoever, for example large tanks with a diameter of 120 mm or small tanks with a diameter of 75 mm.

It is clear that modifications and/or additions of parts may be made to the agitator device as described heretofore, without departing from the field and scope of the present disclosure, as defined by the claims.

It is also clear that, although the present disclosure has been described with reference to some specific examples, a person of skill in the art will be able to achieve other equivalent forms of device for agitating fluid products, having the characteristics as set forth in the claims and hence all coming within the field of protection defined thereby.

In the following claims, the sole purpose of the references in brackets is to facilitate their reading and they must not be considered as restrictive factors with regard to the field of protection defined by the claims.

1. An agitator device comprising:
a plurality of agitation vanes integral with a support element which is rotatable by means of a corresponding drive, said agitation vanes being positioned on said support element according to a distribution in pairs,
wherein each of said pairs defines its own variable section channel delimited at an upper and lower part by said vanes, said channel configured so that, during use, a fluid passes through it, following a substantially helical path in such a way that each variable section channel is part of said path.

2. The agitator device as in claim 1, wherein an inlet section of each of said channels is larger than an outlet section of said channels.

3. The agitator device as in claim 2, wherein each of said channels has a passage section that substantially decreases from said inlet section to said outlet section.

4. The agitator device as in claim 2, wherein in each of said pairs, said vanes are inclined from their bottom upward, with said inlet section located at a bottom end of said channel and said outlet section located at a top end of said channel.

5. The agitator device as in claim 1, wherein the inclination of said vanes is correlated to a direction of rotation of said support element.

6. The agitator device as in claim 1, wherein each of said pairs comprises an upper vane substantially flat and a lower vane that is concave toward the respective channel.

7. The agitator device as in claim 1, wherein the pairs of vanes located on a first side of the support element are offset in height with respect to the pairs of vanes located on a second, opposite side of the support element.

8. The agitator device as in claim 1, wherein said support element is configured as a shaft that develops around a substantially vertical axis.

9. The agitator device as in claim 8, wherein the pairs of vanes located on a first side of the support element are vertically aligned with each other forming a first column of vanes, and the pairs of vanes located on a second, opposite side of the support element are vertically aligned with each other forming a second column of vanes.

10. The agitator device as in claim 9, wherein said first column and said second column are vertical, parallel to one another and to said axis.

11. The agitator device as in claim 9, wherein the outlet section of said pairs of vanes located on the first side of the support element forming said first column is partly overlapping in the vertical direction, for at least one segment, with the inlet section of said pairs of vanes located on the second, opposite side of the support element forming said second column.

12. The agitator device as in claim 7, wherein the vanes located on the first side of said support element are in a diametrically opposite position with respect to the vanes located on the second side.

13. The agitator device as in claim 9, wherein said support element comprises at least two vertical profiles shaped as fins protruding from two opposite parts of said support element, wherein each of said vertical profiles is interposed between said first and second column of vanes.

14. The agitator device as in claim 1, further comprising at least one further vane positioned in proximity to a lower end of said support element and located, during use, in proximity to a bottom of a tank inside which the agitator device is placed.

15. The agitator device according to claim 14, wherein:
each of said pairs of vanes comprises an upper vane substantially flat and a lower vane that is concave toward the respective channel;
the pairs of vanes located on a first side of the support element are vertically aligned with each other forming a first column of vanes, and the pairs of vanes located on a second, opposite side of the support element are vertically aligned with each other forming a second column of vanes; and
said further vane is inclined from the bottom upward with respect to said path and is substantially parallel to said upper vanes arranged in the respective column to which said further vane is aligned on.

16. A tank for containing at least one fluid product, comprising at least one agitator device for agitating said at least one fluid product as in claim 1.
